(19) United States
(12) Patent Application Publication
(10) Pub. No.: US 2010/0020176 A1
(43) Pub. Date: Jan. 28, 2010

(54) IMAGE PROCESSING SYSTEM, IMAGING DEVICE, IMAGE PROCESSING METHOD, AND COMPUTER PROGRAM

(76) Inventor: Kiyoshi HIGASHIBARA, Kanagawa (JP)

Correspondence Address: FROMMER LAWRENCE & HAUG LLP, 745 FIFTH AVENUE, NEW YORK, NY, 10151, US

(21) Appl. No.: 12/507,109

(22) Filed: Jul. 22, 2009

(30) Foreign Application Priority Data
Jul. 24, 2008 (JP) P2008-191488

(51) Int. Cl. H04N 7/18

(52) U.S. Cl. 348/148; 348/E07.085

(57) ABSTRACT

There is provided an image processing system includes an imaging device, a control device for performing image processing, and a display device for displaying the image, the image processing system including an imaging unit for imaging an image of a periphery of a vehicle, a conversion unit for converting the image of the periphery of the vehicle imaged with the imaging unit from a first image to a second image corresponding to a partial region of the first image, an operation unit for performing operation on the display device, and a control unit for controlling the conversion unit and the display device so that when the display device is displaying a third image other than the image imaged with the imaging unit, the second image is displayed after changing a display image from the third image to the first image according to the operation of the operation unit.

### BACKGROUND OF THE INVENTION

1. Field of the Invention

The present invention relates to image processing systems, imaging devices, image processing methods, and computer programs, and more specifically, relates to an image processing system, an image processing method, and a computer program for displaying an image imaged with an imaging device installed in a vehicle, and the imaging device.

2. Description of the Related Art

When driving an automobile, areas that are difficult to see or are unable to see at all from the driver's seat or blind corners exist. In order to view such areas from the driver's seat, there exists an in-vehicle camera system in which a small camera (in-vehicle camera) is mounted at the front part or the rear part of the automobile, and the image photographed with such camera is displayed on an image display device installed at a position visible from the driver's seat of the automobile (see e.g., Japanese Patent Application Laid-Open No. 2002-19556).

The presence of humans approaching the automobile can be checked when driving through a narrow alley, or parking while driving the automobile backwards or parallel parking to a narrow area can be easily carried out by manipulating the steering handle while looking at the image displayed by the relevant in-vehicle camera system.

In the related art, a method of acquiring images of both left and right through a prism to the in-vehicle camera device to photograph the images of the front side on the left and the right of the vehicle is known (see e.g., Japanese Patent Application Laid-Open No. 2001-219783). The images on both left and right sides can be visually checked at once by imaging the images through the prism.

### SUMMARY OF THE INVENTION

However, he method disclosed in Japanese Patent Application Laid-Open No. 2001-219783 has issues such as the application is limited as it is a camera device for imaging through the prism, and the outer shape size of the camera device is large. As imaging is carried out through the prism, the front image may not be obtained, and it is difficult for the driver to instantly recognize which portion is being displayed when looking at the image displayed on the image display device installed at the driver's seat.

In the in-vehicle camera system of the related art, the image photographed with the in-vehicle camera is once converted to the NTSC (National Television Standards Committee) method, and then image processing is performed on the image of after being converted to the NTSC method. However, due to the band pass limitation of the NTSC method, the quality of the image of after being converted to the NTSC method degrades compared to the image of before conversion, and thus the image displayed on the image display device also becomes coarse.

The present invention addresses the above-identified, and other issues associated with methods and apparatuses in related art, and it is desirable to provide a new and improved image processing system capable of allowing the driver to instantly and easily recognize which portion is being displayed, an imaging device, an image processing method, and a computer program.

The present invention also desirably provides a new and improved image processing system in which the quality of the image after conversion displayed on the image display device does not become coarse, an imaging device, an image processing method, and a computer program.

According to an embodiment of the present invention, there is provided an image processing system configured to include an imaging device for imaging an image; a control device for performing image processing on the image imaged with the imaging device; and a display device for displaying the image subjected to the image processing by the control device; the image processing system including: an imaging unit for imaging an image of a periphery of a vehicle; a conversion unit for converting the image of the periphery of the vehicle imaged with the imaging unit from a first image to a second image corresponding to a partial region of the first image; an operation unit for performing operation on the display device; and a control unit for controlling the conversion unit and the display device so that when the display device is displaying a third image other than the image imaged with the imaging unit, the second image is displayed after changing a display image from the third image to the first image according to the operation of the operation unit.

According to such configuration, the imaging device images the image, the control device performs image processing on the image imaged with the imaging device, and the display device displays the image processed in the control device. In the image processing system having such configuration, the imaging unit images the image of the periphery of the vehicle, and the conversion unit converts the image of the periphery of the vehicle imaged with the imaging unit from the first image to the second image corresponding to the partial region of the first image. The operation unit performs operation on the display device, and the control unit controls the conversion unit and the display device such that when the display device is displaying a third image other than the image imaged with the imaging unit, the second image is displayed after changing the display image from the third image to the first image according to the operation of the operation unit. As a result, according to the image processing system provided according to one standpoint of the present invention, the image quality of the image after conversion does not degrade, and the driver can instantly and easily recognize which portion is being displayed.

The operation of the operation unit may be pushing a button once. The first image may be an image of a front side of the vehicle, the second image may be an image of the front side on the left and the right corresponding to the partial region of the image of the front side, and the third image may be map information.

The conversion unit may perform conversion such that history of conversion from the first image to the second image is known.

The image processing system may include the imaging device for imaging the image and the control device for controlling the image processing on the image imaged with the imaging device, and the conversion unit may be included in the imaging device.

The image processing system includes the imaging device for imaging the image and the control device for controlling the image processing on the image imaged with the imaging device, and the conversion unit may be included in the control device.

The conversion unit may perform conversion from RAW data obtained as a result of imaging with the imaging unit, and the conversion unit may perform conversion from an image of after coding RAW data obtained as a result of imaging with the imaging unit.

According to another embodiment of the present invention, there is provided an imaging device including: an imaging unit for imaging an image of a periphery of a vehicle; and a conversion unit for converting the image imaged with the imaging unit from a first image to a second image corresponding to a partial region of the first image based on a conversion instruction from the outside.

According to such configuration, the imaging device images the image, and the conversion unit converts the image imaged with the imaging unit from the first image to the second image corresponding to the partial region of the first image based on the conversion instruction made from the outside. As a result, according to the image processing system provided according to another standpoint of the present invention, the image quality of the image after conversion does not degrade, and the driver can instantly and easily recognize which portion is being displayed.

According to another embodiment of the present invention, there is provided an image processing method including the steps of: imaging an image of a periphery of a vehicle; displaying the image of the periphery of the vehicle imaged in the imaging step; converting the image of the periphery of the vehicle imaged in the imaging step from a first image to a second image corresponding to a partial region of the first image; and performing control so that when a display device is displaying a third image other than the image imaged with an imaging unit, the second image is displayed after changing a display image from the third image to the first image according to the operation on the display device for displaying the image displayed in the displaying step.

According to another embodiment of the present invention, there is provided a computer program for causing a computer to execute the steps of: imaging an image of a periphery of a vehicle; displaying the image of the periphery of the vehicle imaged in the imaging step; converting the image of the periphery of the vehicle imaged in the imaging step from a first image to a second image corresponding to a partial region of the first image; and performing control so that when a display device is displaying a third image other than the image imaged with an imaging unit, the second image is displayed after changing a display image from the third image to the first image according to the operation on the display device for displaying the image displayed in the displaying step.

According to the present invention described above, an image processing system that allows the driver to easily recognize which portion is being displayed is provided by displaying the second image corresponding to the partial region of the first image after displaying the first image in accordance with the operation. Since the second image is displayed after display changing from the third image to the first image by pushing the button once, the driver can easily recognize which portion is being displayed without performing the operation over plural times, whereby the image processing system with improved usability can be provided.

### BRIEF DESCRIPTION OF THE DRAWINGS

FIG. 1 is an explanatory view showing a state in which a vehicle mounted with an image processing system according to a first embodiment of the present invention is looked down from above;

FIG. 2 is an explanatory view describing a configuration of an image processing system 100 according to the first embodiment of the present invention;

FIG. 3 is an explanatory view describing a configuration of an imaging device 110 according to the first embodiment of the present invention;

FIG. 4 is an explanatory view describing a configuration of an ECU 130 according to the first embodiment of the present invention;

FIG. 5 is an explanatory view showing one example of a screen of the car navigation system displayed on the display device 160;

FIG. 6 is an explanatory view showing one example of an image live view displayed on the display device 160;

FIG. 7 is an explanatory view showing an image displayed on the display device 160;

FIG. 8 is an explanatory view showing an image displayed on the display device 160;

FIG. 9 is a flowchart describing the image processing method by the image processing system 100 according to the first embodiment of the present invention; and

FIG. 10 is an explanatory view describing a configuration of an imaging device 210 according to a second embodiment of the present invention.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### First Embodiment

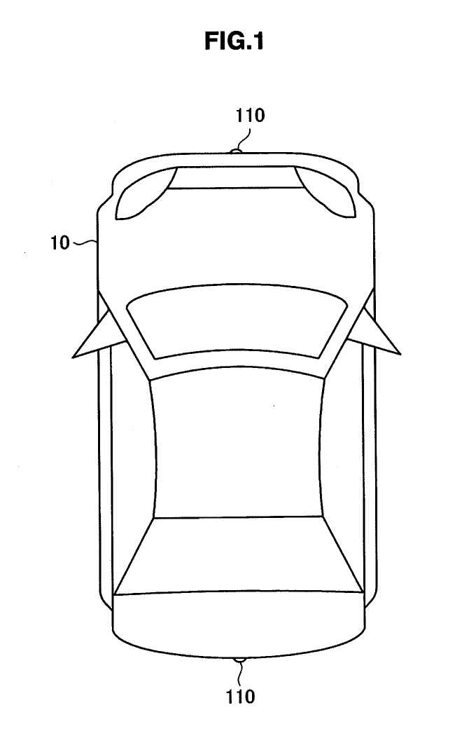

First, an image processing system and an image processing method according to a first embodiment of the present invention will be described. FIG. 1 is an explanatory view showing a state in which a vehicle mounted with the image processing system according to the first embodiment of the present invention is looked down from above.

As shown in FIG. 1, a vehicle 10 mounted with the image processing system according to the first embodiment of the present invention is installed with an imaging device 110 for imaging images at a central portion on the front side. The imaging device 110 according to the present embodiment is an imaging device having a lens in which a view angle is a wide view angle exceeding 180 degrees.

The image processing system according to the present embodiment displays the image, which is imaged using the imaging device 110 having the lens of wide view angle, on a display device installed at a driver's seat of the vehicle 10. The driver driving the vehicle 10 checks the image imaged with the imaging device 110 through the display device to visually check the area that is difficult to see or is unable to see as it becomes a blind corner from the driver's seat.

Although the imaging device 110 is installed at the central portion on the front side of the vehicle 10 in the present embodiment, it should be recognized that the area for installing the imaging device is not limited to such example in the present invention. The number of imaging devices to install in the vehicle 10 may be two or more.

The image processing system and the image processing method according to the first embodiment of the present invention will be specifically described below.

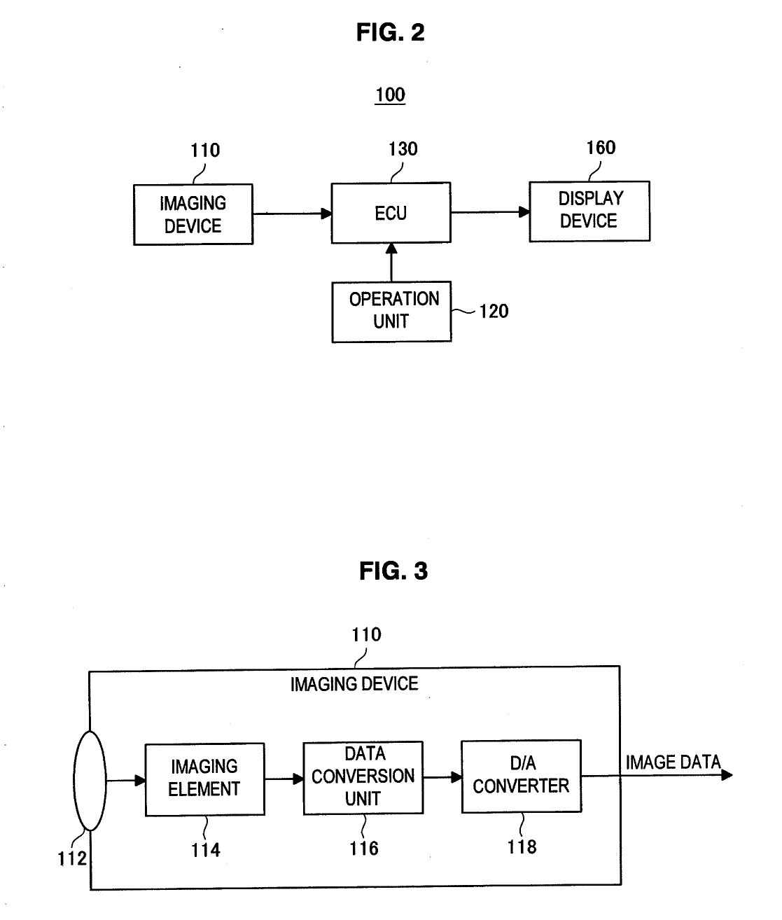

FIG. 2 is an explanatory view describing a configuration of an image processing system 100 according to the first embodiment of the present invention. The configuration of the image processing system 100 according to the first embodiment of the present invention will be described below using FIG. 2.

As shown in FIG. 2, the image processing system 100 according to the first embodiment of the present invention is configured to include the imaging device 110, an operation unit 120, an ECU (Electronic Control Unit) 130, and a display device 160.

The imaging device 110 is installed at the central portion on the front side and the central portion on the rear side of the vehicle 10, as described above, and images the images of the front side, the rear side, and both left and right sides of the vehicle 10. The imaging device 110 is configured to include an imaging element and the like such as a lens in which the view angle is a wide view angle exceeding 180 degrees, a CCD (Charge Coupled Device) image sensor, and a CMOS (Complementary Metal Oxide Semiconductor) image sensor. The image imaged with the imaging device 110 is sent to the ECU 130.

The operation unit 120 accepts the operation input on the image processing system 100. For instance, the image output to the display device 160 can be started and stopped by the operation of the operation unit 120. Furthermore, conversion process of the image to be displayed on the display device 160 can be started, as hereinafter described, by the operation of the operation unit 120. Although not specifically illustrated in the figures, various types of buttons for accepting the operation input on the image processing system 100 are arranged on the operation unit 120.

The ECU 130 is a part for controlling each unit of the vehicle 10, and performs control of the rotation number of the engine, control of the air conditioner, and the like. In the present embodiment, the ECU 130 performs signal processing on the image imaged with the imaging device 110 according to a predetermined instruction. The signal processing on the image imaged with the imaging device 110 performed by the ECU 130, and the details of the predetermined instruction for causing the ECU 130 to execute the signal processing will be described in detail afterwards. The image imaged with the imaging device 110 or the image performed with the signal processing in the ECU 130 is sent to the display device 160.

The display device 160 is installed at a position visible from the driver's seat of the vehicle 10, and performs a so-called live view display of the image imaged with the imaging device 110. The display device 160 may be mounted with an LCD (Liquid Crystal Display), or may be mounted with an organic EL display. A car navigation system is built in the display device 160 according to the present embodiment. The map information of the current location, the route information to the destination, and the like are displayed on the display device 160 by activating the car navigation system. Thus, although not shown in FIG. 1 and FIG. 2, the vehicle 10 may also be equipped with a current location acquiring means such as GPS (Global Positioning System), an autonomous navigation device such as gyro, and the like for the car navigation system.

The driver of the vehicle 10 can visually check the state of the position that is difficult to see or is unable to see as it becomes the blind corner from the driver's seat by looking at the image displayed on the display device 160. In the image processing system 100 according to the present embodiment, the visibility of the driver can be further improved by displaying the video signal processed in the ECU 130 on the display device 160.

The configuration of the image processing system 100 according to the first embodiment of the present invention has been described above using FIG. 2. In FIG. 2 and the above description, description has been made that various types of buttons for accepting the operation input on the image processing system 100 are arranged on the operation unit 120, but the present invention is not limited to such example. The display device 160 may be a touch panel type, so that the driver and the like can touch the buttons displayed on the display device 160 to accept the operation input on the image processing system 100. The configuration of the imaging device 110 according to the first embodiment of the present invention will now be described.

FIG. 3 is an explanatory view describing a configuration of the imaging device 110 according to the first embodiment of the present invention. The configuration of the imaging device 110 according to the first embodiment of the present invention will be described below using FIG. 3.

As shown in FIG. 3, the imaging device 110 according to the first embodiment of the present invention is configured to include a lens 112, an imaging element 114, a data conversion unit 116, and a D/A converter 118.

The lens 112 projects the image of a subject (not shown) on an imaging plane of the imaging element 114. The view angle of the lens 112 according to the first embodiment exceeds 180 degrees as described above. By way of example, the lens in which the view angle is about 186 degrees is used for the lens 112 of FIG. 3.

The imaging element 114 is an element for converting the light entered from the lens 112 to an electric signal. A CCD image sensor may be used, or a CMOS image sensor may be used for the imaging element 114, as described above. The electric signal obtained as a result of converting the light at the imaging element 114 is sent to the data conversion unit 116.

The data conversion unit 116 converts the electric signal generated in the imaging element 114 to a digital signal. The data conversion unit 116 may include a CDS (Correlated Double Sampling) circuit for removing noise components contained in the electric signal generated in the imaging element 114.

The data conversion unit 116 may also include an amplifier circuit for amplifying the electric signal. As a result of conversion in the data conversion unit 116, raw data (RAW data) of the image containing luminance signal digital data and color signal digital data is generated. The digital signal generated in the data conversion unit 116 is sent to the D/A converter 118.

The D/A converter 118 converts the digital signal containing the raw data (RAW data) of the image generated in the data conversion unit 116 to an analog signal for transmission to the ECU 130. The signal converted in the D/A converter 118 is transmitted to the ECU 130 as image data with the raw data of the image coded.

In the present embodiment, the imaging device 110 is configured to include the D/A converter 118, but the present invention is not limited to such example. In other words, if the image data can be transmitted from the imaging device 110 to the ECU 130 in the form of digital signal, the D/A converter 118 may not be used.

The configuration of the imaging device 110 according to the first embodiment of the present invention has been described above using FIG. 3. The configuration of the ECU 130 according to the first embodiment of the present invention will now be described.

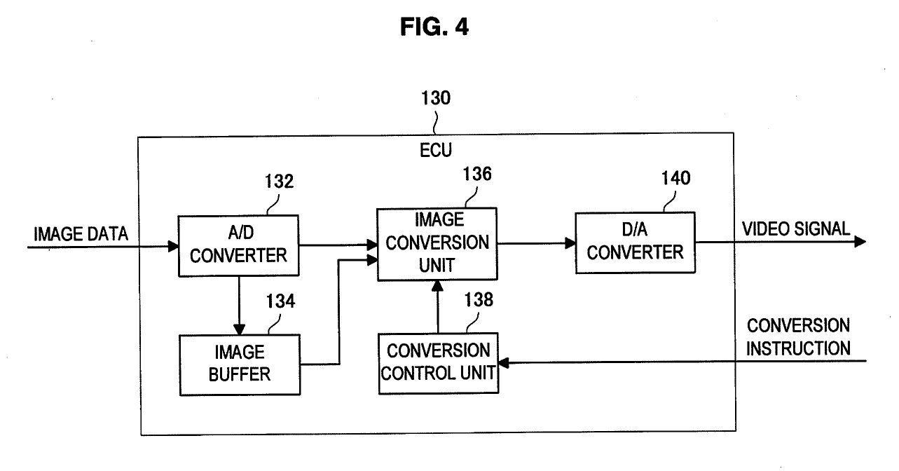

FIG. 4 is an explanatory view describing a configuration of the ECU 130 according to the first embodiment of the present invention. The configuration of the ECU 130 according to the first embodiment of the present invention will be described below using FIG. 4.

As shown in FIG. 4, the ECU 130 according to the first embodiment of the present invention is configured to include an A/D converter 132, an image buffer 134, an image conversion unit 136, a conversion control unit 138, and a D/A converter 140.

The A/D converter 132 converts the image data transmitted from the imaging device 110 to a digital signal. In the present embodiment, the ECU 130 is configured to include the A/D converter 132, but the present invention is not limited to such example. In other words, if the ECU 130 can receive the image data from the imaging device 110 in the form of digital signal, the A/D converter 132 may not be used. The image data converted to the digital signal in the A/D converter 132 is temporarily stored in the image buffer 134.

The image buffer 134 temporarily stores the image data generated in the A/D converter 132 in an FIFO (First In, First Out) style. The image data stored in the image buffer 134 is sent to the image conversion unit 136, and performed with a predetermined conversion process.

The image conversion unit 136 performs a predetermined conversion process according to a conversion instruction when the conversion instruction from the conversion control unit 138 is made on the image data output from the image buffer 134. The image data converted in the image conversion unit 136 is output to the D/A converter 140. The conversion process of the image data executed in the image conversion unit 136 will be described afterwards.

When receiving an input of the conversion instruction signal instructing the conversion of the image from the outside, the conversion control unit 138 sends a conversion instruction of the image data corresponding to the relevant conversion instruction signal to the image conversion unit 136. When receiving the conversion instruction from the conversion control unit 138, the image conversion unit 136 executes the conversion process on the image imaged with the imaging device 110. The conversion control unit 138 also controls the display device 160, the ECU 130, and the imaging device 110 when switch of display from the image of the car navigation system to the image photographed with the imaging device 110 (or vice versa) is instructed with the image of the car navigation system displayed on the display device 160.

The timing the conversion instruction signal is transmitted to the conversion control unit 138 may be a time point when the driver operates the operation unit 120 and the conversion of image is clearly instructed (e.g., time point when the driver pushes the button displayed on the car navigation system) or may be a time point when the speed becomes lower than or equal to a predetermined speed during traveling. The lowering of speed of the vehicle 10 may be detected by the ECU 130 in order to transmit the conversion instruction signal to the conversion control unit 138 with the speed becoming lower than or equal to the predetermined speed during traveling as a trigger. Other than such timing, the imaging device may be installed at the rear part of the vehicle 10, so that the conversion instruction signal is transmitted to the conversion control unit 138 at the time point the vehicle 10 is moved backward when desiring to visually check the image of the rear side of the vehicle 10.

The image conversion unit 136 outputs the image data to the D/A converter 140 without converting the image if the conversion instruction is not sent from the conversion control unit 138.

The D/A converter 140 converts the image data output from the image conversion unit 136 to the NTSC method, for example, to transmit to the display device 160. The signal converted in the D/A converter 140 is transmitted to the display device 160 as a video signal. Although the ECU 130 includes the D/A converter 140 in the present embodiment, the present invention is not limited to such example. In other words, if the image data can be transmitted from the ECU 130 to the display device 160 in the form of digital signal, the ECU 130 may be configured to not include the D/A converter 140.

The configuration of the ECU 130 according to the first embodiment of the present invention has been described using FIG. 4. The image conversion process in the ECU 130 according to the first embodiment of the present invention will now be described with reference to the drawings.

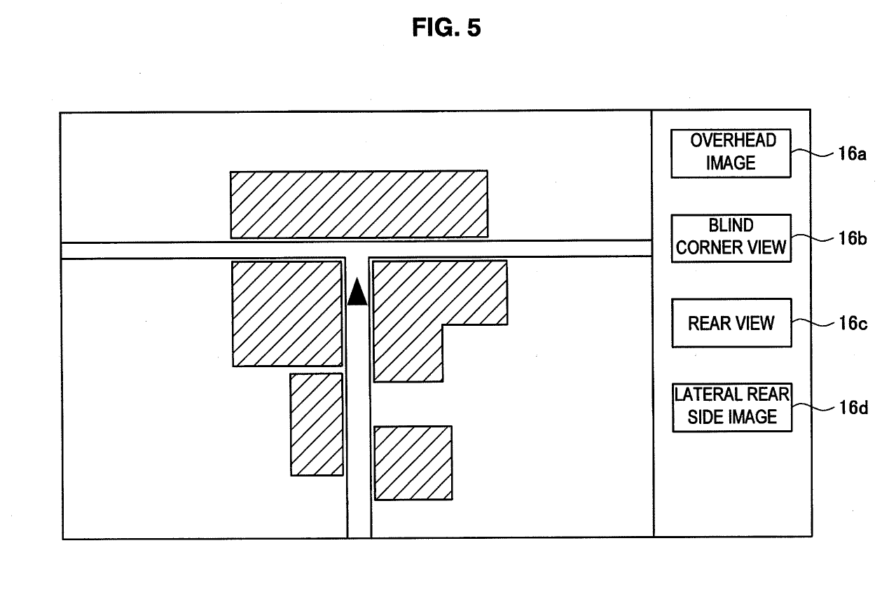

FIG. 5 is an explanatory view showing one example of a screen of the car navigation system displayed on the display device 160. In the present embodiment, an overhead image button 16a, a blind corner view button 16b, a rear view button 16c, and a lateral rear side image button 16d are displayed on the right side of a map image in which a map indicating the current location is displayed in the screen of the car navigation system displayed on the display device 160. In the present embodiment, each button displayed on the display device 160 reacts by touching the screen with the finger, and the operation assigned to each button is executed.

The overhead image button 16a is a button for displaying on the display device 160 an image converted as if imaged from the upper part of the vehicle 10 from the image imaged with the imaging device 110. Such conversion process can be carried out in the ECU 130.

The blind corner view button 16b is a button for displaying on the display device 160 the image of the front side on the left and the right of the vehicle 10 imaged with the imaging device 110 installed on the front side of the vehicle 10. In the present embodiment, when displaying on the display device 160 the image of the front side on the left and the right of the vehicle 10 by touching the blind corner view button 16b with the finger, the image imaged with the imaging device 110 is converted so as to display the image of the front side on the left and the right of the vehicle 10 after once displaying the image on the front side of the vehicle 10. The conversion process will be hereinafter described in detail.

The rear view button 16c is a button for displaying on the display device 160 the image of the rear side of the vehicle 10 imaged with the imaging device 110 installed on the rear side of the vehicle 10. The lateral rear side image button 16d is a button for displaying on the display device 160 the image of the rear side of the side part (lateral rear side) of the vehicle 10 imaged with the imaging device 110 installed on the rear side of the vehicle 10.

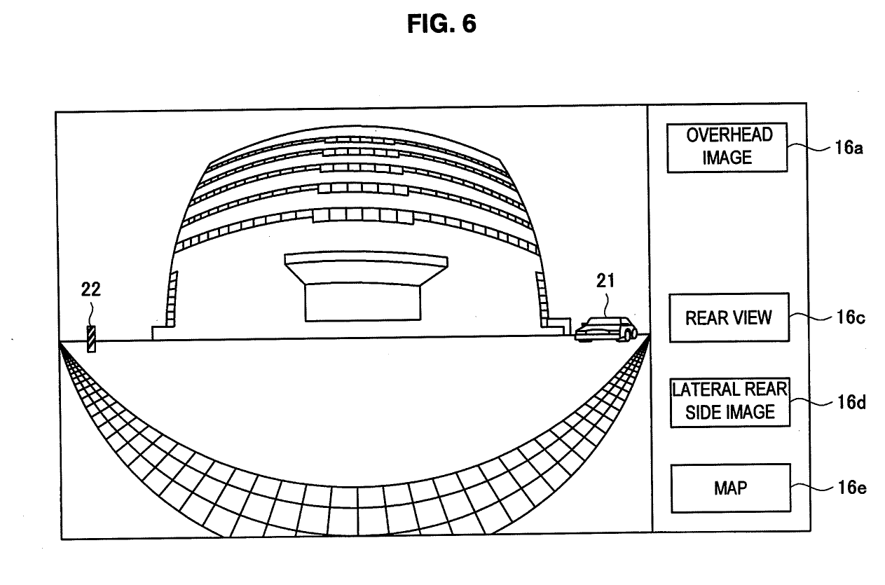

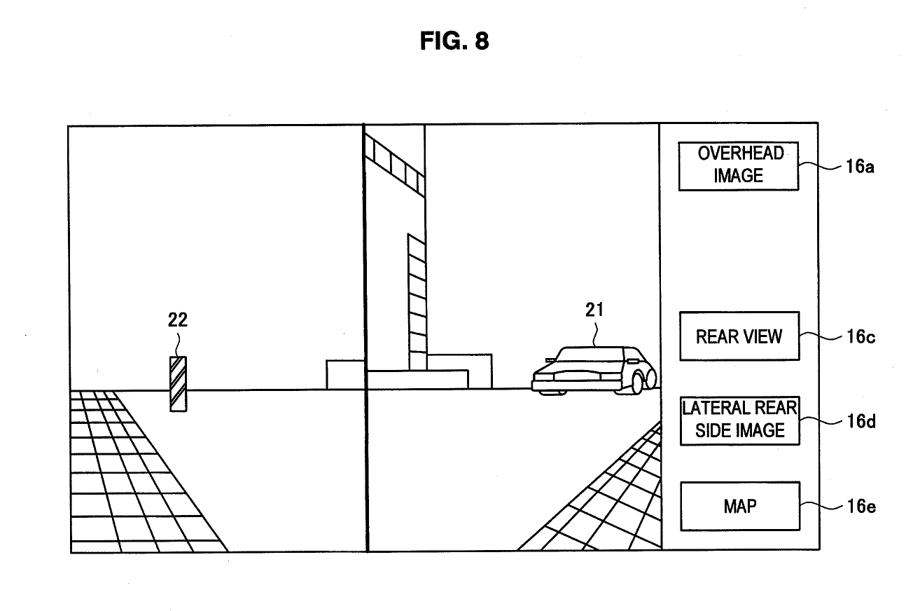

The state shown in FIG. 5 is a state in which the vehicle attempts to reach the T-shaped intersection but the left and right direction is a blind corner from the driver as buildings exist. In this state as well, the vehicles and humans present at the blind corner can be recognized by checking the image of the front side on the left and the right photographed with the imaging device 110 installed on the front side of the vehicle. Therefore, the vehicles and humans present at the blind corner can be adequately checked by displaying the image of the front side on the left and the right as shown in FIG. 8, as hereinafter described. However, for the driver, it is difficult to recognize where the vehicle body 21 and the poll 22 exist, that is, it is difficult to recognize at which part of the front side the vehicle body 21 and the poll 22 exist when the image of FIG. 5 is suddenly switched to the image of FIG. 8. When the blind corner 16b button is pushed in the state of FIG. 5, control is made such that the image on the front side shown in FIG. 6, to be hereinafter described, is displayed, and thereafter, the image shown in FIG. 8, which is an image corresponding to partial region of the image on the front side, is displayed. The approximate position on the front side where the vehicle body 21 and the poll 22 exist can be easily recognized, and the sense of uncomfortable feeling can be reduced. Control is made to display the image of FIG. 8 after changing the display from the image of FIG. 5 to the image of FIG. 6 by pushing the blind corner 16b button only once. The operation of plural times is not necessary, which is convenient to the driver.

FIG. 6 is an explanatory view showing one example of a screen displayed on the display device 160 when the blind corner view button 16b shown in FIG. 5 is touched with the finger, and shows one example of an image imaged with the imaging device 110 according to the first embodiment of the present invention, and live view displayed on the display device 160. As described above, the lens 112 mounted on the imaging device 110 according to the first embodiment of the present invention is a lens in which the view angle is a wide view angle exceeding 180 degrees. Therefore, as shown in FIG. 6, the image imaged with the imaging device 110 is an image displayed over a wide range, but is an image in which distortion produced towards the peripheral edge.

In the first embodiment of the present invention, the conversion process is executed in the image conversion unit 136 so that an object positioned at an area difficult to be visually checked from the driver's seat of the vehicle 10 can be easily visually checked from the image. When executing the conversion process, which portion is being displayed can be notified in an easily understandable manner by smoothly transitioning from the image before conversion to the image after conversion (execute morphing process).

One example of a conversion pattern of the image according to the first embodiment of the present invention is shown. It should be recognized that the conversion pattern of the image described below is not limited to such example in the present invention.

In FIG. 6, a case in which the blind corner view button 16b of the buttons shown in FIG. 5 is in a non-display state, and a map display button 16e for displaying the map image shown in FIG. 5 on the display device 160 is displayed is shown, but it should be recognized that the display form of the button is not limited to such case. The image displayed in FIG. 6 is produced with distortion, but is not limited thereto, and it should be recognized that the image in which the distortion is corrected may be displayed.

When the blind corner view button 16b is pushed with the image shown in FIG. 5 displayed on the display device 160, the display device 160, the ECU 130, and the imaging device 110 are first controlled to display the image shown in FIG. 6. Such control is performed by the conversion control unit 138 arranged inside the ECU 130. The section for carrying out the relevant control in the present invention is not limited to the conversion control unit 138, and a control means (not shown) for executing the relevant control may be arranged inside the display device 160 and the control may be carried out by the control means. In response to the push-operation of the blind corner view button 16b, the conversion instruction signal is sent to the conversion control unit 138, so that the conversion control unit 138 instructs the image conversion unit 136 to execute the conversion process of the image. The image conversion unit 136 receiving the instruction to execute the conversion process of the image performs the conversion process on the image imaged with the imaging device 110, and outputs the image of after the conversion.

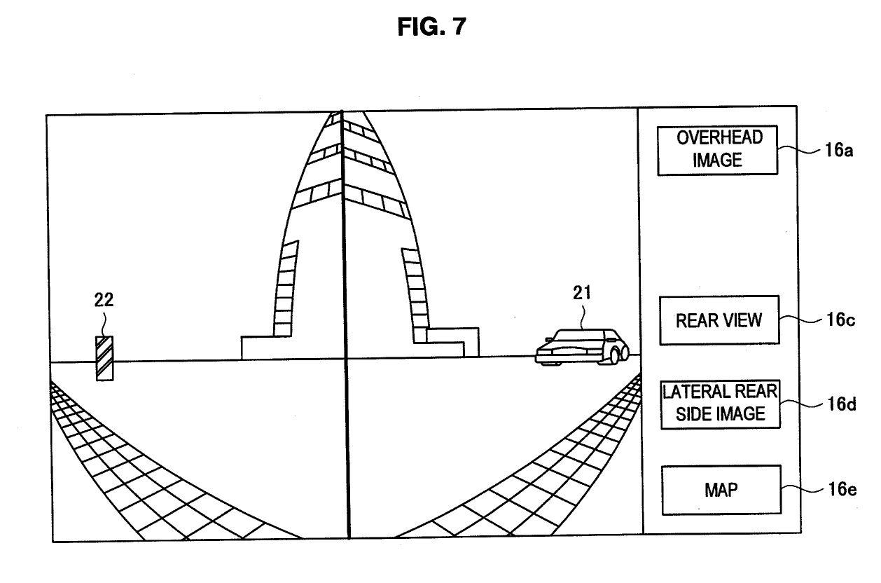

FIGS. 7 and 8 are explanatory views showing an image output from the image conversion unit 136 as a result of the conversion process in the image conversion unit 136 and displayed on the display device 160. FIG. 7 shows one state in the course of reaching the state shown in FIG. 8.

In the present embodiment, the feature lies in that when the conversion process is started in the image conversion unit 136, the state shown in FIG. 6 smoothly transitions to the state shown in FIG. 8 through the state shown in FIG. 7. In the image conversion unit 136, a process of correcting the distortion of the peripheral edge in the image shown in FIG. 6 is executed to realize the image shown in FIG. 8.

The technique disclosed in Japanese Patent Application Laid-Open No. 2007-67714, Japanese Patent Application Laid-Open No. 2007-329548, and the like filed earlier by the applicant of the subject specification can be used for the technique of correcting the distortion of the peripheral edge of the image.

One example of the technique of correcting the distortion of the peripheral edge of the image will be described. For instance, when correcting the distortion in the horizontal direction in the image before and after the conversion, the distortion in the horizontal direction of an original image is corrected by performing a one-dimensional interpolation calculation on the original image using a horizontal correction parameter indicating the correction amount in the horizontal direction at a pixel point configuring the original image. When correcting the distortion in the vertical direction, the distortion in the vertical direction of the original image is corrected by performing a one-dimensional interpolation calculation using a vertical correction parameter indicating the correction amount in the vertical direction at a pixel point configuring the original image using the image obtained as a result of correcting the distortion in the horizontal direction.

The boundary line is shown in the vertical direction of the image in the screens shown in FIGS. 7 and 8, but the boundary line is given for the sake of convenience of the explanation, and thus the boundary line may be given to the image in the middle of conversion or the image after the conversion, or may not be given in the present invention.

Next, the image processing method by the image processing system 100 according to the first embodiment of the present invention will be described below.

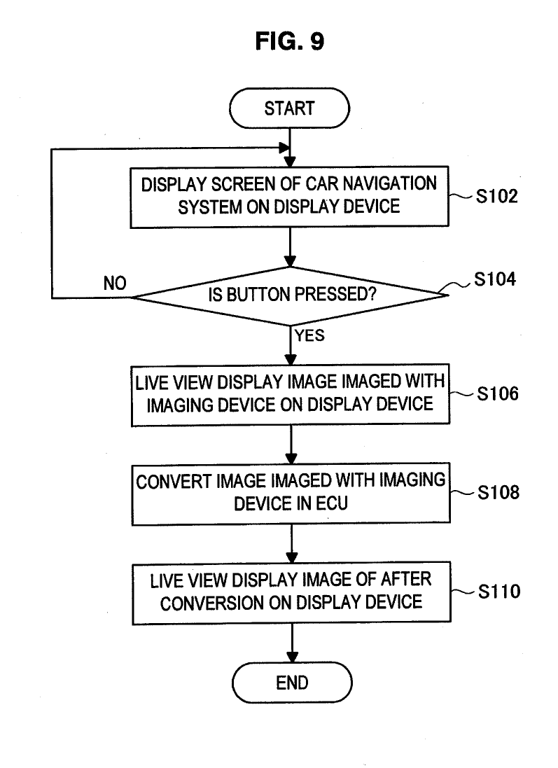

FIG. 9 is a flowchart describing the image processing method by the image processing system 100 according to the first embodiment of the present invention. The image processing method by the image processing system 100 according to the first embodiment of the present invention will be described below using FIG. 9.

First, with the map screen by the car navigation system displayed on the display device 160 (step S102), whether or not the blind corner view button 16b is pushed (whether or not touched with the finger) by the driver is determined (step S104). The determination on whether or not the blind corner view button 16b is pushed (whether or not touched with the finger) may be made by the conversion control unit 138 of the ECU 130.

If determined that the button operation of the blind corner view button 16b is not performed by the driver as a result of the determination of step S104, the process returns to step S102, and the display of the screen of the car navigation system on the display device 160 is continued.

If determined that the button operation of the blind corner view button 16b is performed by the driver as a result of the determination of step S104, the photograph of the image on the front side of the vehicle 10 is started using the imaging device 110 installed at the central portion on the front side of the vehicle 10. The imaging process by the imaging device 110 may be carried out from before the button operation of the blind corner view button 16b is performed. The image photographed with the imaging device 110 is transmitted to the ECU 130. When receiving the transmission of the image photographed with the imaging device 110, the ECU 130 live view displays the relevant photographed image on the display device 160 (step S106). The image displayed on the display device 160 at this time point is an image not performed with the conversion process in the image conversion unit 136, as shown in FIG. 6.

Subsequently, the image photographed with the imaging device 110 is smoothly converted in the image conversion unit 136 of the ECU 130 to have the image displayed on the display device 160 to the image shown in FIG. 8 (step S108).

Specifically, as described above, conversion is made to ultimately display the image shown in FIG. 8 on the display device 160 from the image shown in FIG. 6 through the state of the image shown in FIG. 7. The conversion process is executed in the image conversion unit 136 so that the image to display on the display device 160 smoothly changes from the state shown in FIG. 6 to the state shown in FIG. 8 through the state shown in FIG. 7.

When the conversion process is performed in the image conversion unit 136 of the ECU 130, the image after the conversion process is performed in the image conversion unit 136 is live view displayed on the display device 160 (step S110).

The image processing method by the image processing system 100 according to the first embodiment of the present invention has been described above using FIG. 9. The image processing method by the image processing system 100 according to the first embodiment of the present invention shown in FIG. 9 performs the conversion process of the image with the button operation of the operation unit 120 by the driver as a trigger, but it should be recognized that the present invention is not limited to such example.

For instance, when the vehicle 10 is traveling and the image photographed with the imaging device 110 is displayed on the display device 160, whether or not the speed of the vehicle 10 becomes lower than or equal to a predetermined speed during traveling may be determined. Whether or not the speed is lower than or equal to the predetermined speed is the criteria of determination because it is assumed that there is a need to check the arrival of vehicles, humans and the like from the left and the right when the vehicle 10 advances into the intersection. In such case, the conversion process of step S108 may be executed when determined that the speed of the vehicle 10 is lower than or equal to the predetermined speed.

When the imaging device is installed at the rear part of the vehicle 10 and the image on the rear side of the vehicle 10 is desired to be visually checked, whether or not the vehicle 10 is moved backward may be determined. The conversion process of step S108 may be executed when determined that the vehicle 10 is moved backward.

As described above, according to the first embodiment of the present invention, the image photographed with the imaging device 110 having wide view angle property installed at the central portion on the front side of the vehicle 10 is subjected to the conversion process in the ECU 130 and displayed on the display device 160. When executing the conversion process, the conversion process is executed such that the image to display on the display device 160 smoothly changes at before and after the conversion.

The driver can easily check which portion is zoomed up and displayed by smoothly changing the image to display on the display device 160. An image similar to the image using the prism can be obtained through the conversion process even with the image that may not be obtained unless the prism is used in the related art. Furthermore, the image of the front portion that may not be photographed if the prism is used can also be photographed, which leads to lowering in cost of the system.

The image processing is performed on the image of after converted to the NTSC method in the related art, but in the first embodiment of the present invention, high image quality is maintained in the image of after the conversion since image processing is performed on the image of before being converted to the NTSC method. Consequently, the visibility of the image when the driver looks at the image of after the conversion can be further enhanced.

The image processing in the image conversion unit 136 may be performed by storing a computer program in the ECU 130 and sequentially reading out and executing the stored computer program.

### Second Embodiment

In the first embodiment of the present invention, the image conversion unit 136 is arranged in the ECU 130, and the conversion process of the image photographed with the imaging device 110 is executed in the ECU 130. In the second embodiment of the present invention, a case where the image conversion unit is arranged in the interior of the imaging device will be described.

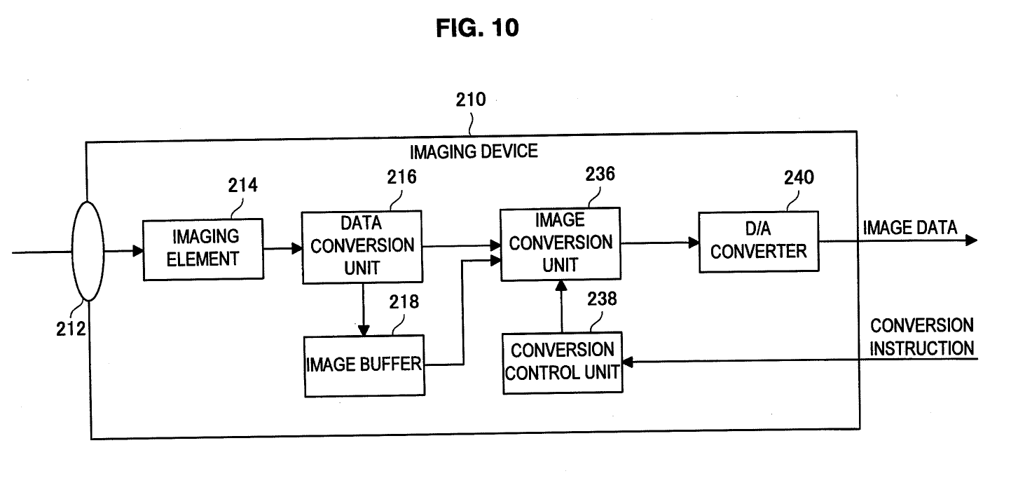

FIG. 10 is an explanatory view describing a configuration of an imaging device 210 according to the second embodiment of the present invention. The configuration of the imaging device 210 according to the second embodiment of the present invention will be described below using FIG. 10.

The imaging device 210 replaces the imaging device 110 described in the first embodiment of the present invention. In other words, the imaging device 210 is installed at the central portion on the front side of the vehicle 10, and photographs the image of the front side portion of the vehicle 10. As shown in FIG. 10, the imaging device 210 according to the second embodiment of the present invention is configured to include a lens 212, an imaging element 214, a data conversion unit 216, an image buffer 218, an image conversion unit 236, a conversion control unit 238, and a D/A converter 240.

Of the configuration of the imaging device 210 shown in FIG. 10, the lens 212, the imaging element 214, and the data conversion unit 216 each has functions similar to the lens 112, the imaging element 114, and the data conversion unit 116 shown in FIG. 3, and thus the detailed description will be omitted.

Furthermore, of the configuration of the imaging device 210 shown in FIG. 10, the image buffer 218, the image conversion unit 236, and the conversion control unit 238 each has functions similar to the image buffer 134, the image conversion unit 236, and the conversion control unit 238 of the ECU 130 shown in FIG. 4. Therefore, in the second embodiment of the present invention, the image imaged using the lens 212 and the imaging element 214 is converted at the interior of the imaging device 210.

The configuration of the imaging device 210 according to the second embodiment of the present invention has been described above using FIG. 10.

As described above, according to the second embodiment of the present invention, the image photographed with the imaging device 210 having wide view angle property installed at the central portion on the front side of the vehicle 10 is subjected to the conversion process in the imaging device 210 and displayed on the display device 160. When executing the conversion process, the conversion process is executed such that the image to display on the display device 160 smoothly changes at before and after the conversion.

The driver can easily check which portion is zoomed up and displayed by smoothly changing the image to display on the display device 160 at the interior of the imaging device 210. An image similar to the image using the prism can be obtained through the conversion process with the imaging device 210 alone even with the image that may not be obtained unless the prism is used in the related art. Furthermore, the image of the front portion that may not be photographed if the prism is used can also be photographed, which leads to lowering in cost of the system.

The image processing is performed on the image of after converted to the NTSC method in the related art, but in the second embodiment of the present invention, high image quality can be maintained in the image of after the conversion since image processing is performed on the image of before being converted to the NTSC method. Moreover, since the conversion process is executed inside the imaging device 210 in the second embodiment of the present invention, the conversion process can be performed directly on the raw data (RAW data) of the image acquired in the imaging element 214. Consequently, the visibility of the image when the driver looks at the image of after the conversion can be further enhanced.

The present application contains subject matter related to that disclosed in Japanese Priority Patent Application JP 2008-191488 filed in the Japan Patent Office on Jul. 24, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

For instance, in the above-described embodiments, the image is created based on the original image of any given time, and thus the overall image shown in FIG. 6 and the image divided in half shown in FIG. 8 create the image based on different original images, but the present invention is not limited to such example. In other words, the overall image shown in FIG. 6 and the image divided in half shown in FIG. 8 may create the image based on the same original image.

The tilt angle of the image may be detected in the image conversion unit 136, for example, even if the imaging device 110 is obliquely installed with respect to the vehicle 10. The image imaged with the imaging device 110 may be converted in the image conversion unit 136 based on the tilt angle detected in the image conversion unit 136.

In the above-described embodiments, when the conversion process starts in the image conversion unit 136, the state shown in FIG. 6 is smoothly transitioned to the state shown in FIG. 8 through the state shown in FIG. 7, but the present invention is not limited to such example. For instance, when the conversion process starts in the image conversion unit 136, the state shown in FIG. 6 may be instantaneously transitioned to the state shown in FIG. 8.

What is claimed is:

1. An image processing system configured to include
an imaging device for imaging an image;
a control device for performing image processing on the image imaged with the imaging device; and
a display device for displaying the image subjected to the image processing by the control device; the image processing system comprising:
an imaging unit for imaging an image of a periphery of a vehicle;
a conversion unit for converting the image of the periphery of the vehicle imaged with the imaging unit from a first image to a second image corresponding to a partial region of the first image;
an operation unit for performing operation on the display device; and
a control unit for controlling the conversion unit and the display device so that when the display device is displaying a third image other than the image imaged with the imaging unit, the second image is displayed after changing a display image from the third image to the first image according to the operation of the operation unit.

2. The image processing system according to claim 1, wherein the operation of the operation unit is pushing a button once.

3. The image processing system according to claim 2, wherein the first image is an image of a front side of the vehicle, the second image is an image of the front side on the left and the right corresponding to the partial region of the image of the front side, and the third image is map information.

4. The image processing system according to claim 3, wherein the conversion unit performs conversion such that history of conversion from the first image to the second image is known.

5. The image processing system according to claim 1, wherein the conversion unit is included in the imaging device.

6. The image processing system according to claim 1, wherein the conversion unit is included in the control device.

7. The image processing system according to claim 1, wherein the conversion unit performs conversion from RAW data obtained as a result of imaging with the imaging unit.

8. The image processing system according to claim 1, wherein the conversion unit performs conversion from an image of after coding RAW data obtained as a result of imaging with the imaging unit.

9. An imaging device comprising:
an imaging unit for imaging an image of a periphery of a vehicle; and
a conversion unit for converting the image imaged with the imaging unit from a first image to a second image corresponding to a partial region of the first image based on a conversion instruction from the outside.

10. An image processing method comprising the steps of:
imaging an image of a periphery of a vehicle;
displaying the image of the periphery of the vehicle imaged in the imaging step;
converting the image of the periphery of the vehicle imaged in the imaging step from a first image to a second image corresponding to a partial region of the first image; and
performing control so that when a display device is displaying a third image other than the image imaged with an imaging unit, the second image is displayed after changing a display image from the third image to the first image according to the operation on the display device for displaying the image displayed in the displaying step.

11. A computer program for causing a computer to execute the steps of:
imaging an image of a periphery of a vehicle;
displaying the image of the periphery of the vehicle imaged in the imaging step;
converting the image of the periphery of the vehicle imaged in the imaging step from a first image to a second image corresponding to a partial region of the first image; and
performing control so that when a display device is displaying a third image other than the image imaged with an imaging unit, the second image is displayed after changing a display image from the third image to the first image according to the operation on the display device for displaying the image displayed in the displaying step.
